(19) United States
(12) Patent Application Publication
(10) Pub. No.: US 2018/0332155 A1
(43) Pub. Date: Nov. 15, 2018

(54) Fidget Tool Phone Case

(71) Applicants: Robert Alexander Babbage, III, Lexington, KY (US); Benjamin Joseph Keith Wilson, Lexington, KY (US)

(72) Inventors: Robert Alexander Babbage, III, Lexington, KY (US); Benjamin Joseph Keith Wilson, Lexington, KY (US)

(21) Appl. No.: 15/978,412

(22) Filed: May 14, 2018

Related U.S. Application Data
(60) Provisional application No. 62/505,679, filed on May 12, 2017.

(51) Int. Cl. H04M 1/21; H04B 1/3888; A63H 29/08

(52) U.S. Cl. CPC H04M 1/21; A63H 29/08; H04B 1/3888

(57) ABSTRACT

A fidget tool phone case having a case body, a spinner assembly comprising a spinner housing, a spinner base, a bearing, a spinner arm, and a spinner hub, a click wheel assembly comprising a wheel housing, a wheel housing cover, a plurality of springs, and a plurality of wheels, a slider assembly comprises a slider housing, a slider housing cover, and a slider, and a button assembly comprising a plurality of button housings, a button housing cover, a plurality of button bases, and a plurality of buttons. The spinner arm spins freely relative the case body. The plurality of wheels rotates with resistance from the plurality of springs. The slider moves along a channel aperture of the slider housing. The plurality of buttons is depressible through the plurality of button housings. The fidget tool phone case thus provides a plurality of engagement options for a user.

### CROSS-REFERENCE TO RELATED APPLICATIONS

U.S. Provisional Application No. 62/505,679 Filed May 12, 2017

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### SPECIFICATION

Be it known that we, Robert Alexander Babbage, III, a citizen of the United States, and Benjamin Joseph Keith Wilson, a citizen of Australia, have invented new and useful improvements in a fidget tool phone case as described in this specification. We claim benefit of our provisional application No. 62/505,679, filed on May 12, 2017.

### BACKGROUND OF THE INVENTION

Various types of phone cases are known in the prior art. Phone cases are known to provide a variety of functions, principally protection and aesthetic enhancement. Fidget tools have been shown to help with focus, stress reduction, and even the management of attention disorders. What is needed, and what the present fidget tool phone case provides, is a phone case that provides the user with a means of occupying her fingers, or fidgeting, without needing to carry an additional device or find an object in her surroundings. Thus what is needed is a fidget tool telephone case having a case body, a spinner assembly comprising a spinner housing, a spinner base, a bearing, a spinner arm, and a spinner hub, a click wheel assembly comprising a wheel housing, a wheel housing cover, a plurality of springs, and a plurality of wheels, a slider assembly comprises a slider housing, a slider housing cover, and a slider, and a button assembly comprising a plurality of button housings, a button housing cover, a plurality of button bases, and a plurality of buttons. Finally, what is needed is the spinner arm to rotate freely relative the case body, the plurality of wheels to rotate with resistance from the plurality of springs, the slider to move along a channel aperture of the slider housing, and the plurality of buttons to be depressible through the plurality of button housings.

### FIELD OF THE INVENTION

The present invention relates to phone cases, and more particularly, to a fidget tool phone case.

### SUMMARY OF THE INVENTION

The general purpose of the present fidget tool phone case, described subsequently in greater detail, is to provide a fidget tool phone case that has many novel features that result in a fidget tool phone case that is not anticipated, rendered obvious, suggested, or even implied by prior art, either alone or in combination thereof.

To accomplish this, the present fidget tool phone case includes a case body having an outside, an inside, a main face, a sidewall perpendicularly and continuously disposed along a perimeter of the main face, and a plurality of phone function apertures disposed from the outside to the inside, the plurality of phone function apertures including, but not limited to, a volume control aperture, a power aperture, a camera aperture, and a bottom aperture.

A spinner assembly comprises a spinner housing, a spinner base, a bearing, a spinner arm, and a spinner hub. The spinner housing is medially disposed on the main face of the case body, and has a plurality of tooth receptacles disposed on an inner circumference thereof. Each of the plurality of tooth receptacles has a receptacle slot horizontally disposed therein from a left edge to proximal a right edge. The receptacle slot tapers as it approaches the right edge. In an ideal embodiment of the invention, the plurality of tooth receptacles is evenly spaced around the inner circumference, creating a plurality of notches, with each notch of the plurality of notches disposed between each of the plurality of tooth receptacles. The spinner base has a cylindrical bottom, a bearing axle centrally disposed thereon, and a plurality of engagement teeth disposed on an outer edge of the cylindrical bottom. Each of the plurality of engagement teeth has a first shape substantially conforming to a second shape of each of the plurality of notches. To install the spinner base into the spinner housing, the plurality of engagement teeth is inserted into the plurality of notches, and then rotated into the receptacle slot of the plurality of tooth receptacles, where they remain disposed therein. In the ideal embodiment of the invention, the plurality of engagement teeth and the plurality of notches is three. A lock aperture is medially disposed within the bearing axle through to the cylindrical bottom. The bearing has an inner aperture and an outer circumference, wherein the inner aperture is engageable with the bearing axle of the spinner base using a press fit. The spinner arm is attached to the bearing, and has a pivot aperture medially disposed from a top side to a bottom side thereof. The pivot aperture is engageable with the outer circumference of the bearing using a press fit. The spinner hub is used to connect the spinner arm, the bearing, and the spinner base. The spinner hub has a hub disc and a lock pin disposed on an underside thereof, and the lock pin is inserted into the lock aperture of the bearing axle to secure the spinner arm to the spinner base. The spinner arm is thus configured to spin freely relative the case body, with all rotation occurring within the bearing.

A click wheel assembly comprises a wheel housing, a wheel housing cover, a plurality of springs, and a plurality of wheels. The wheel housing has a wheel cavity, and is disposed on the main face of the case body adjacent a left face of the side wall. The wheel housing has a wheel slot aperture continuously disposed along a height thereof, through the side wall to the wheel cavity. The wheel housing cover is disposed on the inside of the case body adjacent the wheel cavity, and has a plurality of wheel axles and a plurality of spring anchors disposed on an upper surface thereof. The plurality of springs is disposed on the plurality of spring anchors. Each of the plurality of springs has an anchor aperture and an arm, wherein the anchor aperture is engageable with the plurality of spring anchors and the arm protrudes therefrom. The plurality of wheels, each having a plurality of gear teeth and an axle aperture, is disposed such that the axle aperture is engaged with the plurality of wheel axles. The plurality of wheels would thus rotate freely on the plurality of wheel axles, if not for the plurality of springs. The plurality of gear teeth is engageable with the arm of the plurality of springs such that the arm rests between a first tooth and an adjacent tooth of the plurality of gear teeth. Each of the plurality of springs is configured to allow the plurality of wheels to rotate when pushed by flexing the arm until it moves to rest between the adjacent tooth and a second adjacent tooth of the plurality of gear teeth, making a “click” sound as it moves.

A slider assembly comprises a slider housing, a slider housing cover, and a slider. The slider housing has a slider cavity, and is disposed on the main face of the case body. The slider housing has a channel aperture continuously disposed along a length thereof through to the slider cavity. The slider housing cover is disposed on the inside of the case body adjacent the slider cavity. The slider comprises a slider bottom unit and a slider top unit, wherein the slider bottom unit is disposed within the slider cavity. The slider bottom unit has a pair of friction arms and a receptacle protrusion, wherein the pair of friction arms is configured to engage an inner surface of the slider housing in order to create resistance as it is pushed along the channel aperture. The slider top unit has an engagement protrusion that is engageable with the receptacle protrusion of the slider bottom unit once inserted through the channel aperture. The slider top unit thus remains above the channel aperture, while the slider bottom unit remains within the slider cavity.

A button assembly comprises a plurality of button housings, a button housing cover, a plurality of button bases, and a plurality of buttons. The plurality of button housings, each having a button cavity, is disposed on the main face of the case body. Each button housing has a button aperture medially disposed through to the button cavity thereof. The button housing cover is disposed on the inside of the case body adjacent the button cavity of the plurality of button housings. One button base of the plurality of button bases is disposed within the button cavity of each the plurality of button housings. One button of the plurality of buttons is disposed on the button base within each of the plurality of button housings. Each button of the plurality of buttons has a depressible portion disposed through the button aperture, which is configured to be pushed by a user from a rest position to an alternate depressed position. The button and the button base create resistance to this movement, and return the button from the alternate depressed position to the rest position.

Thus have been broadly outlined the more important features of the present fidget tool phone case so that the detailed description thereof that follows may be better understood and in order that the present contribution to the art may be better appreciated.

### BRIEF DESCRIPTION OF THE DRAWINGS

### Figures

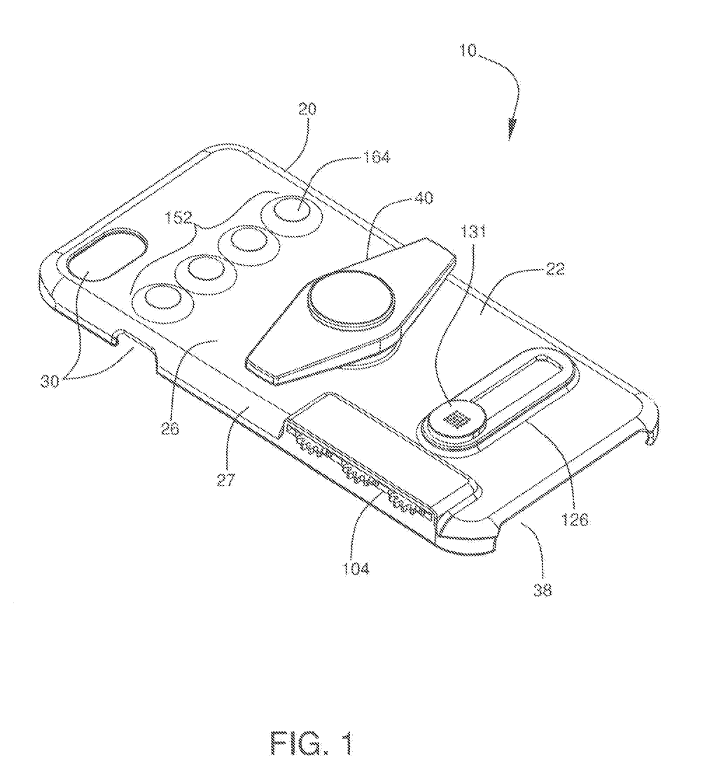

FIG. 1 is a top isometric view of a fidget tool phone case.

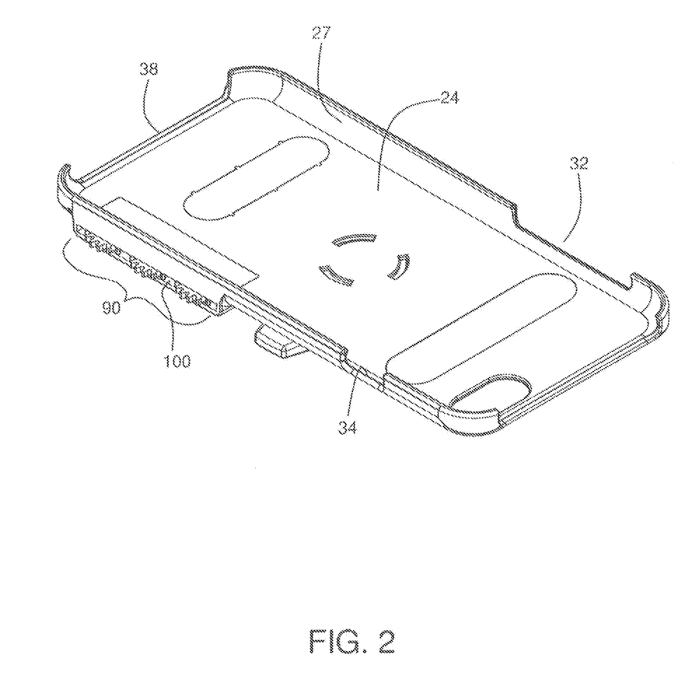

FIG. 2 is a bottom isometric view of the fidget tool phone case.

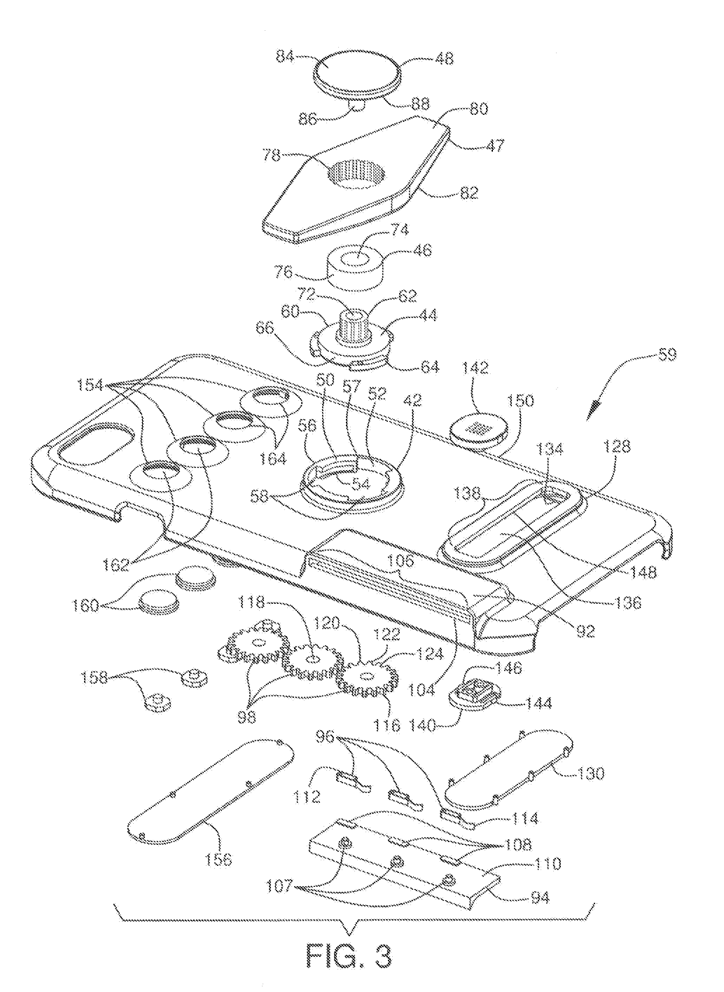

FIG. 3 is an exploded isometric view of the fidget tool phone case.

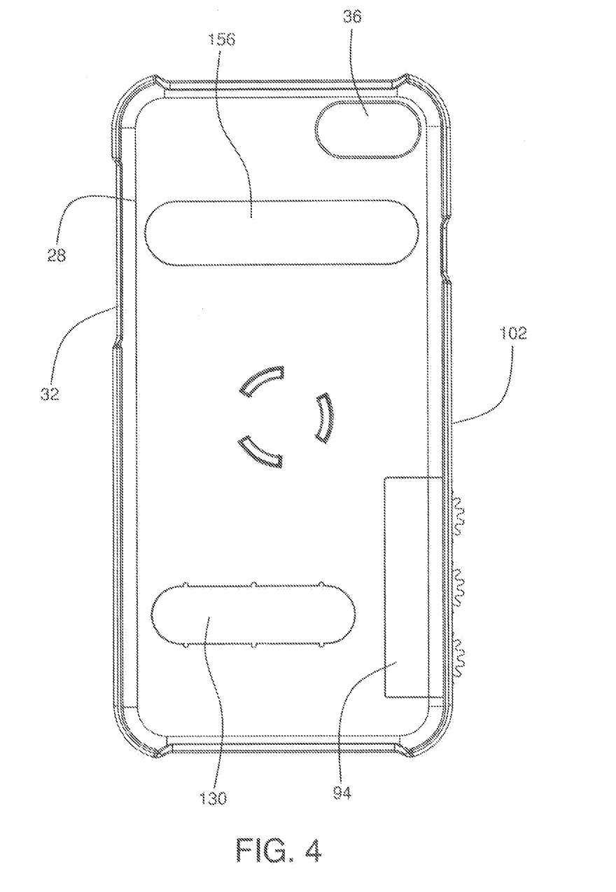

FIG. 4 is a bottom plan view of the fidget tool phone case.

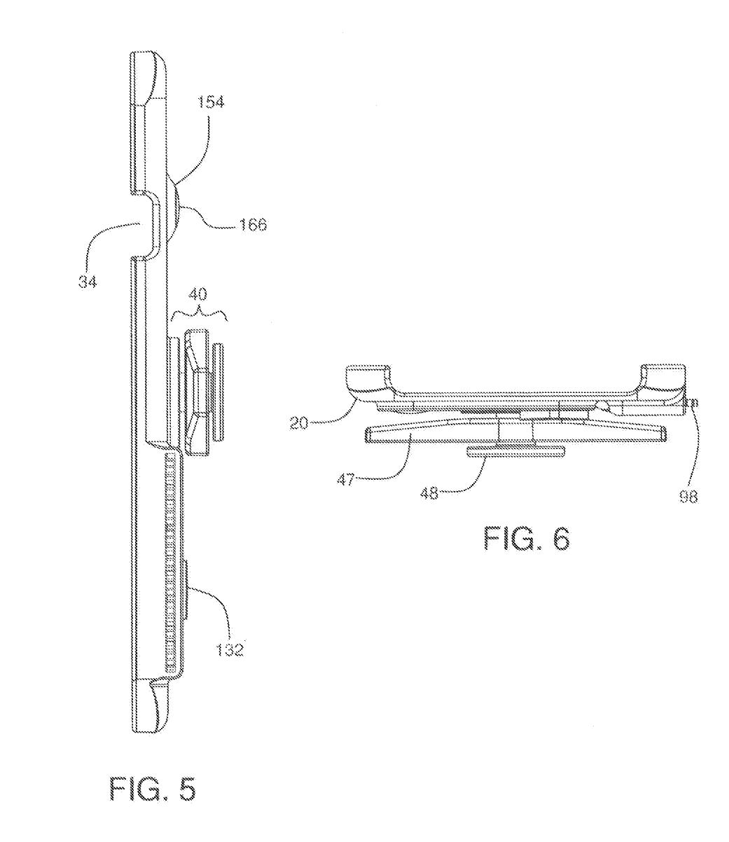

FIG. 5 is a side elevation view of the fidget tool phone case.

FIG. 6 is an alternative side elevation view of the fidget tool phone case.

### DETAILED DESCRIPTION OF THE DRAWINGS

With reference now to the drawings, and in particular FIGS. 1 through 6 thereof, an example of the instant fidget tool phone case employing the principles and concepts of the present fidget tool phone case and generally designated by the reference number 10 will be described.

Referring to FIGS. 1 through 6 the present fidget tool phone case 10 is illustrated. The fidget tool phone case 10 includes a case body 20 having an outside 22, an inside 24, a main face 26, a sidewall 27 perpendicularly and continuously disposed along a perimeter 28 of the main face, and a plurality of phone function apertures 30 disposed from the outside 22 to the inside 24, the plurality of phone function apertures including, but not limited to, a volume control aperture 32, a power aperture 34, a camera aperture 36, and a bottom aperture 38.

A spinner assembly 40 comprises a spinner housing 42, a spinner base 44, a bearing 46, a spinner arm 47, and a spinner hub 48. The spinner housing 42 is medially disposed on the main face 26 of the case body, and has a plurality of tooth receptacles 50 disposed on an inner circumference 52 thereof. Each of the plurality of tooth receptacles has a receptacle slot 54 horizontally disposed therein from a left edge 56 to proximal a right edge 57. The receptacle slot 54 tapers as it approaches the right edge 58. In an ideal embodiment of the invention 59, the plurality of tooth receptacles 50 is evenly spaced around the inner circumference 52, creating a plurality of notches 58, with each notch of the plurality of notches disposed between each of the plurality of tooth receptacles 50. The spinner base 44 has a cylindrical bottom 60, a bearing axle 62 centrally disposed thereon, and a plurality of engagement teeth 64 disposed on an outer edge 66 of the cylindrical bottom 60. Each of the plurality of engagement teeth 64 has a first shape substantially conforming to a second shape of each of the plurality of notches. To install the spinner base 44 into the spinner housing 42, the plurality of engagement teeth 64 is inserted into the plurality of notches 58, and then rotated into the receptacle slot 54 of the plurality of tooth receptacles, where they remain disposed therein. In the ideal embodiment of the invention 59, the plurality of engagement teeth and the plurality of notches is three. A lock aperture 72 is medially disposed within the bearing axle 62 through to the cylindrical bottom 60. The bearing 46 has an inner aperture 74 and an outer circumference 76, wherein the inner aperture is engageable with the bearing axle 62 of the spinner base using a press fit. The spinner arm 47 is attached to the bearing 46, and has a pivot aperture 78 medially disposed from a top side 80 to a bottom side 82 thereof. The pivot aperture is engageable with the outer circumference 76 of the bearing using a press fit. The spinner hub 48 is used to connect the spinner arm, the bearing, and the spinner base. The spinner hub has a hub disc 84 and a lock pin 86 disposed on an underside 88 thereof, and the lock pin is inserted into the lock aperture 72 of the bearing axle to secure the spinner arm 47 to the spinner base 44. The spinner arm is thus configured to spin freely relative the case body 20, with all rotation occurring within the bearing 46.

A click wheel assembly 90 comprises a wheel housing 92, a wheel housing cover 94, a plurality of springs 96, and a plurality of wheels 98. The wheel housing 92 has a wheel cavity 100, and is disposed on the main face 26 of the case body adjacent a left face 102 of the side wall 27. The wheel housing has a wheel slot aperture 104 continuously disposed along a height 106 thereof, through the side wall 27 to the wheel cavity 100. The wheel housing cover 94 is disposed on the inside 24 of the case body adjacent the wheel cavity, and has a plurality of wheel axles 107 and a plurality of spring anchors 108 disposed on an upper surface 110 thereof. The plurality of springs 96 is disposed on the plurality of spring anchors. Each of the plurality of springs has an anchor aperture 112 and an arm 114, wherein the anchor aperture is engageable with the plurality of spring anchors 108 and the arm 114 protrudes therefrom. The plurality of wheels 98, each having a plurality of gear teeth 116 and an axle aperture 118, is disposed such that the axle aperture is engaged with the plurality of wheel axles 106. The plurality of wheels 98 would thus rotate freely on the plurality of wheel axles 106, if not for the plurality of springs 96. The plurality of gear teeth 116 is engageable with the arm of 114 the plurality of springs such that the arm rests between a first tooth 120 and an adjacent tooth 122 of the plurality of gear teeth. Each of the plurality of springs 96 is configured to allow the plurality of wheels 98 to rotate when pushed by flexing the arm 114 until it moves to rest between the adjacent tooth 122 and a second adjacent tooth 124 of the plurality of gear teeth, making a “click” sound as it moves.

A slider assembly 126 comprises a slider housing 128, a slider housing cover 130, and a slider 132. The slider housing has a slider cavity 134, and is disposed on the main face 26 of the case body. The slider housing 128 has a channel aperture 136 continuously disposed along a length 138 thereof through to the slider cavity 134. The slider housing cover 130 is disposed on the inside 24 of the case body adjacent the slider cavity. The slider 132 comprises a slider bottom unit 140 and a slider top unit 142, wherein the slider bottom unit is disposed within the slider cavity 134. The slider bottom unit 140 has a pair of friction arms 144 and a receptacle protrusion 146, wherein the pair of friction arms is configured to engage an inner surface 148 of the slider housing in order to create resistance as it is pushed along the channel aperture 136. The slider top unit 142 has an engagement protrusion 150 that is engageable with the receptacle protrusion 146 of the slider bottom unit once inserted through the channel aperture 136. The slider top unit 142 thus remains above the channel aperture 136, while the slider bottom unit 140 remains within the slider cavity 134.

A button assembly 152 comprises a plurality of button housings 154, a button housing cover 156, a plurality of button bases 158, and a plurality of buttons 160. The plurality of button housings 154, each having a button cavity 162, is disposed on the main face 26 of the case body. Each button housing has a button aperture 164 medially disposed through to the button cavity 162 thereof. The button housing cover is disposed on the inside 24 of the case body adjacent the button cavity of the plurality of button housings. One button base of the plurality of button bases 158 is disposed within the button cavity of each of the plurality of button housings 154. One button of the plurality of buttons 160 is disposed on the button base within each of the plurality of button housings 154. Each button of the plurality of buttons 160 has a depressible portion 166 disposed through the button aperture 164.

What is claimed is:

1. A fidget tool phone case comprising:
a case body having an outside, an inside, a main face, a sidewall perpendicularly and continuously disposed along a perimeter of the main face, and a plurality of phone function apertures disposed from the outside to the inside;
a spinner housing medially disposed on the main face of the case body, the spinner housing having a plurality of tooth receptacles disposed on an inner circumference thereof;
a spinner base having a cylindrical bottom, a bearing axle centrally disposed thereon, and a plurality of engagement teeth disposed on an outer edge of the cylindrical bottom, wherein each of the plurality of engagement teeth is disposed within the plurality of tooth receptacles, wherein a lock aperture is medially disposed within the bearing axle;
a bearing having an inner aperture and an outer circumference, wherein the inner aperture is engageable with the bearing axle of the spinner base;
a spinner arm having a pivot aperture medially disposed from a top side to a bottom side thereof, wherein the pivot aperture is engageable with the outer circumference of the bearing; and
a spinner hub having a hub disc and a lock pin disposed on an underside thereof, wherein the lock pin is engageable with the lock aperture of the bearing axle;
wherein the spinner arm is configured to spin freely relative the case body;
wherein the the spinner housing, the spinner base, the bearing, and the spinner hub comprise a spinner assembly.

2. The fidget tool phone case of claim 1 further comprising:
a wheel housing having a wheel cavity disposed on the main face of the case body adjacent a left face of the side wall, wherein the wheel housing has a wheel slot aperture continuously disposed along a height thereof, through the side wall to the wheel cavity;
a wheel housing cover disposed on the inside of the case body adjacent the wheel cavity, wherein the wheel housing cover has a plurality of wheel axles and a plurality of spring anchors disposed on an upper surface thereof;
a plurality of springs, wherein each of the plurality of springs has an anchor aperture and an arm, wherein the anchor aperture is engageable with the plurality of spring anchors; and
a plurality of wheels, each having a plurality of gear teeth and an axle aperture, wherein the axle aperture is rotatably engageable with the plurality of wheel axles, wherein the plurality of gear teeth is engageable with the arm of the plurality of springs, wherein the arm of each of the plurality of springs is configured to rest between a first tooth and an adjacent tooth of the plurality of gear teeth, and to allow the plurality of wheels to rotate when pushed as the arm flexes and then moves between the adjacent tooth and a second adjacent tooth of the plurality of gear teeth;
wherein the wheel housing, the wheel housing cover, the plurality of springs, and the plurality of wheels comprise a click wheel assembly.

3. The fidget tool phone case of claim 2 further comprising:
a slider housing having a slider cavity disposed on the main face of the case body, the slider housing having a channel aperture continuously disposed along a length thereof through to the slider cavity;
a slider housing cover disposed on the inside of the case body adjacent the slider cavity; and
a slider comprising a slider bottom unit and a slider top unit, wherein the slider bottom unit is disposed within the slider cavity, wherein the slider bottom unit has a pair of friction arms and a receptacle protrusion, wherein the pair of friction arms is configured to slidingly engage an inner surface of the slider housing, wherein the slider top unit has an engagement protrusion, wherein the engagement protrusion is engageable with the receptacle protrusion of the slider bottom unit through the channel aperture;
wherein the slider housing, the slider housing cover, and the slider comprise a slider assembly.

4. A fidget tool phone case as in any of the preceding claims, the fidget tool phone case further comprising:
a plurality of button housings, each having a button cavity, disposed on the main face of the case body, wherein each button housing of the plurality of button housings has a button aperture medially disposed through to the button cavity thereof;
a button housing cover disposed on the inside of the case body adjacent the button cavity of the plurality of button housings;
a plurality of button bases, wherein each button base of the plurality of button bases is disposed within the button cavity of the plurality of button housings;
a plurality of buttons, wherein each button of the plurality of buttons is disposed on the button base within each of the plurality of button housings, wherein each button of the plurality of buttons has a depressible portion disposed through the button aperture;
wherein the plurality of button housings, the button housing cover, the plurality of button bases, and the plurality of buttons comprise a button assembly.

5. A fidget tool phone case comprising:
a case body having an outside, an inside, a main face, a sidewall perpendicularly and continuously disposed along a perimeter of the main face, and a plurality of phone function apertures disposed from the outside to the inside;
a spinner housing medially disposed on the main face of the case body, the spinner housing having a plurality of tooth receptacles disposed on an inner circumference thereof;
a spinner base having a cylindrical bottom, a bearing axle centrally disposed thereon, and a plurality of engagement teeth disposed on an outer edge of the cylindrical bottom, wherein each of the plurality of engagement teeth is disposed within the plurality of tooth receptacles, wherein a lock aperture is medially disposed within the bearing axle;
a bearing having an inner aperture and an outer circumference, wherein the inner aperture is engageable with the bearing axle of the spinner base;
a spinner arm having a pivot aperture medially disposed from a top side to a bottom side thereof, wherein the pivot aperture is engageable with the outer circumference of the bearing;
a spinner hub having a hub disc and a lock pin disposed on an underside thereof, wherein the lock pin is engageable with the lock aperture of the bearing axle;
wherein the spinner arm is configured to spin freely relative the case body;
a wheel housing having a wheel cavity disposed on the main face of the case body adjacent a left face of the side wall, wherein the wheel housing has a wheel slot aperture continuously disposed along a height thereof, through the side wall to the wheel cavity;
a wheel housing cover disposed on the inside of the case body adjacent the wheel cavity, wherein the wheel housing cover has a plurality of wheel axles and a plurality of spring anchors disposed on an upper surface thereof;
a plurality of springs, wherein each of the plurality of springs has an anchor aperture and an arm, wherein the anchor aperture is engageable with the plurality of spring anchors;
a plurality of wheels, each having a plurality of gear teeth and an axle aperture, wherein the axle aperture is rotatably engageable with the plurality of wheel axles, wherein the plurality of gear teeth is engageable with arm of the plurality of springs, wherein the arm of each of the plurality of springs is configured to rest between a first tooth and an adjacent tooth of the plurality of gear teeth, and to allow the plurality of wheels to rotate when pushed as the arm flexes and then moves between the adjacent tooth and a second adjacent tooth of the plurality of gear teeth;
a slider housing having a slider cavity disposed on the main face of the case body, the slider housing having a channel aperture continuously disposed along a length thereof through to the slider cavity;
a slider housing cover disposed on the inside of the case body adjacent the slider cavity;
a slider comprising a slider bottom unit and a slider top unit, wherein the slider bottom unit is disposed within the slider cavity, wherein the slider bottom unit has a pair of friction arms and a receptacle protrusion, wherein the pair of friction arms is configured to slidingly engage an inner surface of the slider housing, wherein the slider top unit has an engagement protrusion, wherein the engagement protrusion is engageable with the receptacle protrusion of the slider bottom unit through the channel aperture;
a plurality of button housings, each having a button cavity, disposed on the main face of the case body, wherein each button housing of the plurality of button housings has a button aperture medially disposed through to the button cavity thereof;
a button housing cover disposed on the inside of the case body adjacent the button cavity of the plurality of button housings;
a plurality of button bases, wherein each button base of the plurality of button bases is disposed within the button cavity of the plurality of button housings; and
a plurality of buttons, wherein each button of the plurality of buttons is disposed on the button base within each of the plurality of button housings, wherein each button of the plurality of buttons has a depressible portion disposed through the button aperture.
